(19) United States
(12) Patent Application Publication
(10) Pub. No.: US 2015/0310660 A1
(43) Pub. Date: Oct. 29, 2015

(54) COMPUTER GRAPHICS WITH ENHANCED DEPTH EFFECT

(71) Applicant: Sony Computer Entertainment America LLC, San Mateo, CA (US)

(72) Inventors: Bret Mogilefsky, Castro Valley, CA (US); Richard B. Stenson, San Mateo, CA (US)

(73) Assignee: Sony Computer Entertainment America LLC, San Mateo, CA (US)

(21) Appl. No.: 14/262,646

(22) Filed: Apr. 25, 2014

(51) Int. Cl. G06T 15/40; G06T 1/60

(52) U.S. Cl. CPC G06T 15/405; G06T 1/60

(57) ABSTRACT

Systems and methods for processing three-dimensional graphics depicting a sequence of motion with an enhanced illusion of depth are described. The graphics may include three-dimensional content mapped to a two dimensional viewing window with an additional reference image rendered onto the viewing window. The reference image may be defined at one or more portions of the viewing window and rendered as occluding the content or being occluded by the content depending on the depth of the content at each portion of the viewing window.

### FIELD

Aspects of the present disclosure relate to three-dimensional graphics processing and image sequences which provide an enhanced illusion of three-dimensional depth for the viewer.

### BACKGROUND

Most display devices rely on two-dimensional arrays of pixels or otherwise rely on two-dimensional images in order to present graphics to a viewer, even though the underlying content of the graphics may be three-dimensional (e.g., rendered 3D computer graphics, real-life recorded content, and the like). While adequate, a certain dimension of depth is lost for the viewer when displaying 3D graphics on two-dimensional displays in this manner, and many attempts have been made to develop technologies that can provide a rich illusion of 3D depth in order to enhance the visual experience for the viewer.

Traditional techniques for simulating an illusion of 3D depth often rely on principles of stereoscopy to present a 3D image to the viewer that simulates the illusion of depth. Stereoscopy relies on two offsetting images which are combined together as a 3D image, with the two offsetting images being presented separately to each of the left and right eyes of the viewer, respectively. Each offsetting image is itself a two-dimensional image of the same content, but these left and right eye images are separately perceived by each eye and combined in the brain in order to provide the illusion of depth. The offset in the images essentially simulates the way humans ordinarily perceive depth using their offsetting left and right eyes in the real world, thus creating the illusion of depth.

Unfortunately, while stereoscopic displays have been around for many decades, they have never quite achieved the type of mainstream popularity to replace conventional two-dimensional displays. Often, stereoscopic display devices require special sets of glasses which are cumbersome for the viewer. Moreover, some form of dedicated hardware is needed in order to present the stereoscopic images, which increases the cost and renders stereoscopic images unsuitable for viewing on many existing display devices.

Recently, a technique for simulating an illusion of depth has been attempted for small sequences of frames known as “3D GIFs”, which rely on a small set of images stored in a single animated GIF (graphics interchange format) file. Ordinary, two-dimensional GIFs cycle through a small sequence of images, typically a handful of frames, from a pre-recorded or pre-rendered video in order to create a short animation having the illusion of motion. 3D GIFs are typically animated in a similar manner to these ordinary two-dimensional GIFs, but incorporate certain features to enhance a 3D effect of the frame sequence, making it appear as if certain pre-selected objects of the image are popping out at the viewer in order to simulate an illusion of motion in a depth direction, without requiring any special stereoscopic or three-dimensional display device.

Traditionally, 3D GIFs accomplish this feat primarily by using at least one of the following techniques.

A first technique utilizes a set of vertically oriented solid white bars that are fixed to the frames through which the underlying scene contents are depicted. As the animation progresses through the sequence of frames and content elements in the scene change position during the animation, the positions of these bars relative to the scene remain fixed in a static position throughout the animation to essentially define a reference plane for the viewer at the position of the screen. Furthermore, these vertical bars initially completely occlude a portion of the contents of the scene where they are located, completely obstructing the view of underlying objects of the frame. This gives the appearance that the obstructed portions are behind the bars. As the animation progresses to later frames in the sequence, portions of the bars are selectively removed to give an appearance that one or more pre-selected objects, manually determined by the 3D GIF creator to be perceived as moving in a depth direction, have moved in front of these bars (closer to the viewer) and have crossed the plane defined by these bars. This creates the illusion that the pre-selected objects are moving closer to the viewer, in a depth direction, as the animation progresses, thereby simulating a 3D effect for the viewer.

Another way some traditional 3D GIFs attempt to enhance the illusion of depth is through the focus characteristics of the scene. For example, in some instances the depth of field is altered as the animation progresses to later frames in the sequence. The depth of field may initially be large so that a wide range of the scene is in focus, including not only the preselected object, but also much of the background and other objects in the scene. As the animation progress, the depth of field shrinks in such a manner that the preselected object remains in focus, but much of the background and other distant objects go out of focus. The resulting blurring effect of the distant objects in the later frames then enhances a perceived degree to which the preselected object has moved in the depth direction as the animation progresses to the later stages. In some instances, the size of the depth of field may remain static, but the location of focus in the depth direction may be used to enhance the illusion. For example, the location of focus may closer to the viewer in the depth direction, e.g., closer to the screen, and the preselected object may be initially located in the distant background and out of focus. As the object moves closer to the viewer, it comes into better focus because its motion in the depth direction brings it closer to the focal point. Both of these techniques that are based on the focus characteristics essentially rely on the enhanced illusion of depth that results from out of focus background objects.

Unfortunately, these traditional techniques are only suitable for short sequences of predetermined frames and require careful manual manipulation of the images by a human creator. Manual observation is needed in order to determine which elements are supposedly moving in the depth direction and to adjust the visual characteristics of the frames accordingly. Moreover, without careful selection by the human creator, important elements of the scene might be occluded, and the added effects might be more distracting to the viewer.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIGS. 1A-1D are schematic diagrams depicting a sequence of motion having an enhanced 3D effect according to aspects of the present disclosure.

FIGS. 2A-2D are schematic diagrams depicting another sequence of motion having an enhanced 3D effect according to additional aspects of the present disclosure.

FIGS. 3A-3D are schematic diagrams depicting another sequence of motion having an enhanced 3D effect according to additional aspects of the present disclosure.

FIGS. 4A-4H are schematic diagrams depicting different examples of reference image according to various implementations of the present disclosure.

FIGS. 5A-5B are flow diagrams depicting a method of rendering graphics with an enhanced 3D effect according to aspects of the present disclosure. FIG. 5A depicts a method of rendering 3D content with a reference image, and FIG. 5B depicts a more detailed flow diagram for rendering the reference image depicted in FIG. 5A.

FIG. 6 is a flow diagram depicting a method of rendering graphics in accordance with the method depicted in FIGS. 5A-5B using a polygon based graphics rendering pipeline according to aspects of the present disclosure.

FIG. 7 is a schematic diagram of a system configured to render graphics according to aspects of the present disclosure.

### DETAILED DESCRIPTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Aspects of the present disclosure include techniques to enhance a three-dimensional effect for video and sequences of graphics frames. Certain implementations of the present disclosure may be suitable for real-time applications, such as video gaming and other computer graphics rendered in response to user inputs, where a three-dimensional effect may be added automatically by a graphics processing system without prior knowledge of the underlying contents of the scene.

According to certain aspects, a three-dimensional effect may be provided by rendering a scene through a viewing window, with a reference image fixed to the scene's viewing window. In certain implementations, the reference image may be rendered relative to objects in the scene based on information contained in a depth buffer, e.g., a Z-buffer in graphics memory, for a 3D graphics rendering pipeline. Since a depth buffer is often already maintained for hidden surface removal and z-culling for the contents within the scene, the depth buffer provides a way for the system to automatically overlay an additional reference image onto the contents of the scene in a manner that enhances an illusion of depth based on the depth of content elements within the scene.

According to certain additional aspects, the reference image may also be fixed to a viewing window by generating the reference image with a pixel shader, which may provide an intuitive way for an application to render a reference image fixed to a viewing window. When combined with information in a depth buffer, the depth of objects relative to the reference image may be easily determined on a per-pixel basis to render the reference image on the fly in a manner that enhances a three-dimensional effect.

According to certain additional aspects, the reference image may include certain features that prevent it from completely occluding a view of underlying objects in the scene. For example, the reference image may be semi-transparent and allow obstructed objects to be partially visible through the reference image in some fashion. Since the contents of the scene may not be known in advance, this may avoid distraction and occlusion of important objects of the scene by the reference image.

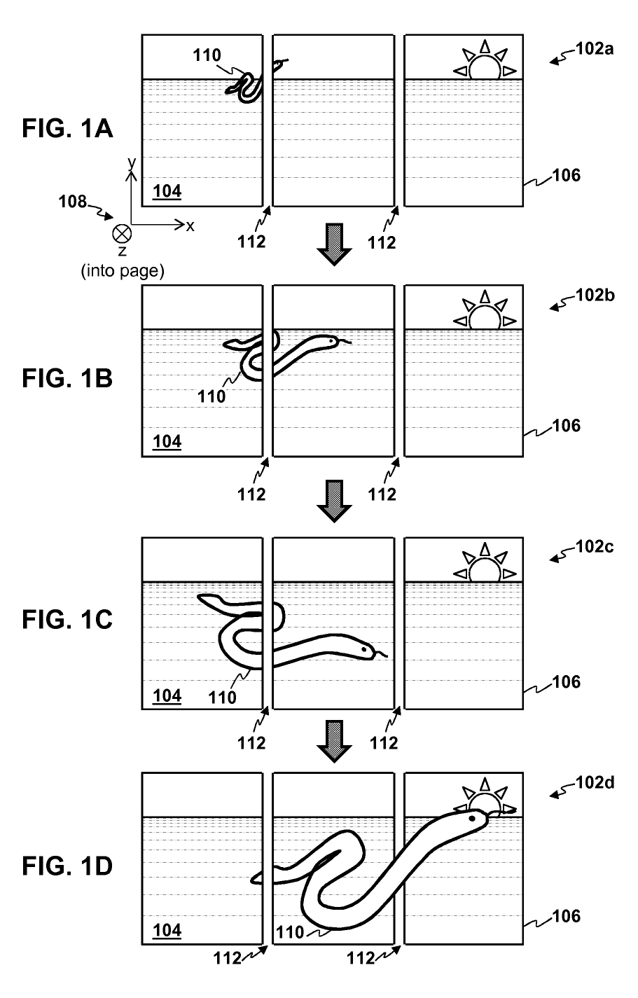

In order to illustrate certain aspects of the present disclosure, FIGS. 1A-1D depict an example of a sequence of motion rendered with an overlaid reference image to provide an enhanced illusion of 3D depth. Each of the different illustrated images of FIGS. 1A-1D may correspond to a different point in time in the motion sequence. In the illustrated example, different points in time of the motion sequence are depicted as different frames 102a-d in a motion sequence containing 3D graphics in FIGS. 1A-1D, respectively.

The illustrated graphics depict three-dimensional scene content 104 that is made up of one or more objects, and the three-dimensional content 104 is mapped to a two-dimensional viewing window 106 lying at a two-dimensional image plane of the scene. Conceptually, the image plane may be understood to lie at the location in the scene that corresponds to the display screen for the viewer, and the viewing window 106, sometimes known as a “viewport” in computer graphics, may be understood to define the bounds of that image plane through which the underlying contents 104 of the scene are represented in the frames 102a-d.

In this example, the image plane may correspond to the plane of a display device when the graphics are presented to a viewer, and the viewing window 106 may be a region of the image plane, e.g., a rectangular region corresponding to a conventional rectangular display screen or rectangular array of display pixels, which defines to the portion of the three-dimensional content that is displayed. The three-dimensional content 104 may be mapped to the two-dimensional window 106 in order to present the content 104 as two-dimensional images 102a-d, e.g., via a rasterization process that projects the three-dimensional contents onto the two-dimensional plane of the viewing window 106. In certain implementations, the viewing window 106 may be a virtual camera which is used to capture computer generated graphics. If the three-dimensional content were to be real-life content that is captured with a physical camera, the viewing window would correspond to the camera lens as focused onto the detector plane, e.g., the film or array of pixels sensors used to capture the real-life three-dimensional content.

In the implementation depicted in FIGS. 1A-1D, the three-dimensional content 104 may be defined with reference to a coordinate system 108. In the illustrated schematic, a Cartesian X-Y-Z coordinate system is used. The X and Y coordinates correspond to the horizontal and vertical axes of the viewing window 106, while the Z-direction corresponds to a depth axis of the scene. In this example, the horizontal, vertical, and depth axes are labeled X, Y, and Z, respectively, but it is understood, that equivalent axes may be readily defined with different labels without departing from the scope and spirit of the directions defined therein. Furthermore, in certain implementations, alternative coordinate systems besides Cartesian coordinates may be used to define horizontal and vertical locations on the viewport, as well as depths of the contents, in an equivalent manner to the illustrated Cartesian coordinate system. Moreover, it is understood that while the illustrated example depicts “left-handed” Cartesian coordinates, where the Z-axis extends into the page and away from the viewer so that higher Z-values correspond to deeper elements, it is understood that a right-handed Cartesian coordinate system would be equivalent and simply have reversed direction for the Z-axis, with lower Z-values corresponding to deeper elements.

In the implementation depicted in FIGS. 1A-1D, the one or more objects depicted by the frames 102a-d include a first object 110 that is moving in a depth direction (Z-direction) in the 3D world in the scene. In this example, the first object 110 is illustrated as a snake that is slithering closer to the viewer in the depth direction as the sequence progresses to the later frames over time. In order to enhance a three-dimensional illusion of depth to the snake's movement, the frames are also formed with a reference image 112 overlaid onto the contents of the scene. The reference image 112 is fixed to the viewing window 106 of the scene so that a reference plane is defined for the viewer. The reference image may appear conceptually to lie at the plane of the screen for the viewer and thus lie at the image plane of the scene. However, in various implementations, the reference image 112 may be defined to lie at any specific depth relative to the viewing window, e.g., any specific Z-depth value.

As shown in FIGS. 1A-1D, the snake is initially occluded by the reference image and initially is located far away in the scene, e.g., it has a depth value that is beyond the defined depth threshold reference image and appears far away from the viewer. Accordingly, as can be seen in the earlier frames 102a-c, it is at least partially occluded by the reference image 112, and the reference image is drawn over this object. As the snake moves closer to the image plane of the viewing window 106 and closer to the viewer, its depth value decreases. In frame 102d depicted in FIG. 1D, it has crossed the depth threshold of the reference image 112 and now appears to pop out of the screen at the viewer, since at least a portion of the object's depth is no longer beyond the defined depth threshold of the reference 112. In order to achieve this effect, the portion of the snake is now drawn or rendered over the reference image so as to occlude a portion thereof, in contrast to the previous frames where the entire snake was farther away in the scene and occluded by the reference image at all locations of the viewing window where the reference image was defined on the viewing window 106.

Since the reference image 112 is fixed to the viewing window 106, rather than being a part of the underlying contents 104 of the virtual world, the reference image may have the feeling to the viewer as being located in the viewer's space, e.g., it may be perceived in the viewer's mind as being attached to the display device or located at the plane of the display screen. As the contents of the scene change due objects moving around, camera panning, camera zooming, and the like, the reference image 112 may be fixed to the viewing window in some fashion, rather than falling out of view or changing position on the viewing window with the contents of the scene. When an object suddenly occludes the reference image, it may thus appear to the viewer as if the object is popping out of the screen or is otherwise closer to the viewer. It is noted that the object 110, e.g., the snake in the illustrated example, may actually have different depths at different portions of the image. Specifically, a common object 110 may have different depths (Z) at different pixels in the frame or different horizontal and vertical (X-Y) positions of the viewing window. As shown in FIG. 1D, the snake's tail portion is deeper in the scene than its head portion. Thus, a portion of the object 110 may be occluded by part of the reference image 112 and be drawn behind it, since this portion is beyond the depth threshold of the reference image, while another portion of this same object may instead occlude the reference image and be drawn over it, since this other portion of the snake 110 is below the depth threshold of the reference image, as shown in the illustrative example of FIG. 1D.

In the implementation depicted in FIGS. 1A-1D, the reference image 112 is drawn as a completely opaque reference image. As a result, the view to the portion of the scene contents 104 located behind the reference image 112 is completely obstructed by the reference image. In this example, the pixels of the reference image, e.g., at the horizontal and vertical coordinates of the viewing window where these pixels are drawn, are completely white and none of the underlying scene contents 104 that map to these portions of the viewing window 106 are visible to the viewer at these locations.

In certain implementations of the present disclosure, it may be undesirable to completely obstruct any portion of the scene in this manner. For example, in a live interactive game, a view to important game elements may be hidden from the user and playability of the game may be degraded. It may also be undesirable in other computer applications where the reference image is generated automatically by the system on the fly, since important objects in the scene might be hidden from viewer in a distracting manner, and the system might not otherwise discriminate between important and unimportant elements. Therefore, certain implementations of the present disclosure may incorporate reference images with characteristics that allow scene contents to be partially seen through a reference image.

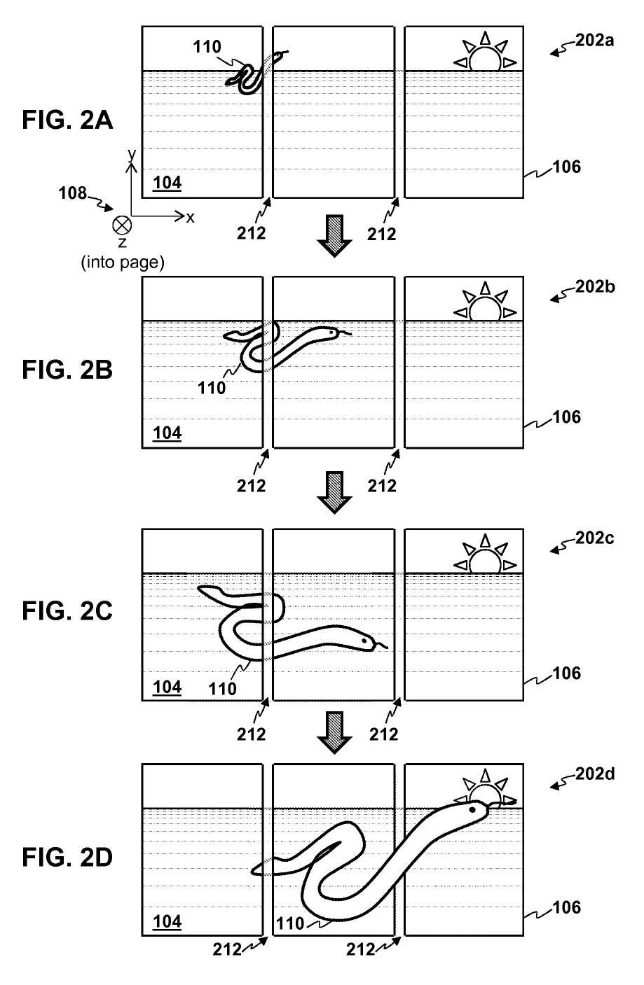

FIGS. 2A-2D depict an example sequence of frames 202a-d having a partially see-through reference image 212 that renders the underlying scene contents 104 occluded by the reference image 212 still partially visible through the reference image 212. The example frame sequence depicted in FIGS. 2A-2D is similar to the example depicted in FIGS. 1A-1D; however, in the illustrated implementation, at the subset of the viewing window that is defined to include the reference images, e.g., those horizontal and vertical coordinates of the viewing window 106 where the reference image 212 is defined, occluded scene contents are rendered as partially visible, so that their visibility is lowered, but not completely eliminated.

More specifically, in the example frame sequence depicted in FIGS. 2A-2D, the reference image 212 is semi-transparent, rather than completely opaque. It is noted that implementations of the example depicted in FIGS. 2A-2D may include a variety of different degrees and types of transparencies, so long as the portion of the 3D contents 104 that is occluded by the reference image is not completely invisible (i.e., as it would appear with an opaque reference image) or completely visible (i.e., unaltered as it would appear with no reference image).

By way of example, and not by way of limitation, the semi-transparent reference image may appear similar to tinted glass so that the color of the obscured scene contents 104 is altered to some degree. As another example, a semi-transparent reference image may also include a blurring effect, and the reference image may appear similar to fogged glass or some other type of element which blurs the underlying contents to some degree. In certain implementations, the reference image may be incorporated into a real-time application, and the transparency of the reference image may be configurable by the user in the form a slider or other user setting that allows the degree of transparency to be set according to user preferences.

It is noted that by using a degree of transparency, as shown in the illustrative example of FIGS. 2A-2B, a system may be able to automatically generate a reference image 212 onto scene contents 104 without concern for obscuring important elements. This may be particularly useful in gaming and other interactive implementations, since the playability of the game may be reduced if important interactive elements are obscured.

In the illustrated example of FIGS. 2A-2D, the reference image appears semitransparent because it is rendered in such a manner as to reduce the amount of perceived light transmitted through the reference image from the occluded contents. However, it may also be possible to render occluded contents as partially visible by rendering the reference image as a refractive element which simulates bending of light, so that the contents 104 of the scene which are obscured by the reference image 212 appear distorted, but are still visible. For example, this may be accomplished by rendering the reference image 212 as one or more glass bars having a convex or concave surface.

It is noted that the reference image should be fixed to the viewing window so that, as underlying contents of the graphics change and the viewing window pans and changes position, the reference image remains attached to the viewer's reference point during the motion sequence in which the 3D effect is enhanced by the reference image. However, although this reference is fixed to the viewing window, it does not have to be fixed in a static position or fixed in a static form as the motion sequence progresses. Rather, in certain implementations of the present disclosure, the reference image may be dynamic, and change in one or more characteristics as the motion sequence progresses. For example, in certain implementations, the reference may change in size, shape, position, color, transparency, or any combination thereof.

The choice of whether to implement a static or dynamic reference image may depend on the nature of the particular motion sequence being depicted. In certain implementations, it may be desirable to use a static reference image throughout the particular sequence of motion, e.g., sequence of frames, to which the 3D effect is being applied, in order to more firmly bring the reference image out of the scene contents and into the viewer's world. For example, the horizontal and vertical position of the reference image on the viewing window may remain static and constant across different increments of time during the sequence of motion, e.g., across frames, and the portion of the viewing window that is defined to contain the reference image may be constant over time.

However, in other implementations, it may be desirable to utilize a dynamic reference image, in order to adapt to the contents of the scene, changes to the viewing perspective, or for some other reason. For example, when a scene cuts to a different camera perspective, the reference image may cut to a different portion of the viewing window or change form in a manner that is better suited to the altered contents or new perspective. By way of further example, the reference image may be defined to change in a gradual manner in relation to underlying contents. For example, the reference image may be defined as a pair of bars that gradually separate further and further apart as a camera zooms in, and closer together as a camera zooms out, thereby enhancing an illusion of depth motion of the viewport. By way of another example, the reference image may also be defined as one or more bars that each gradually get thicker as a camera zooms in, and gets thinner as the camera zooms out, creating a similar illusion of depth motion for the viewer perspective.

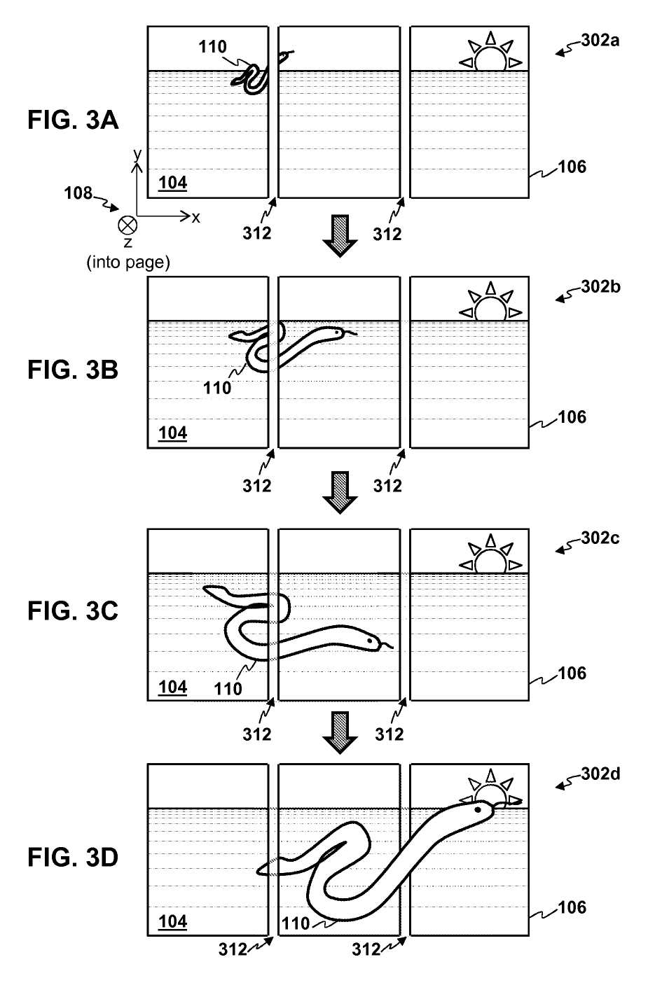

FIGS. 3A-3D depict an example of a sequence of frames having an enhanced 3D effect that is similar to the sequences depicted in FIGS. 1A-1D and 2A-2D, except in this example, the reference image 312 is dynamic and one or more characteristics of the reference image change as the motion sequence depicted by the graphics progresses. In the example depicted in FIGS. 3A-3D, the transparency of the reference image 312 changes as the motion sequence progress to later stages in the motion sequence.

Specifically, in the illustrated implementation, the reference image 312 is initially opaque, as shown in the frame 302a depicted in FIG. 3A. Thus, portions of the scene contents 104, including the object 110, that are occluded by the reference image are not initially visible. However, as shown in FIG. 3B, the reference image transitions into an altered reference image that allows occluded scene contents 104 to be partially visible. Specifically, in the illustrated example, the reference image 312 transitions into a semi-transparent reference image.

In the illustrated example, the degree of transparency gradually changes as the scene progress to later stages of the motion sequence, e.g., later graphics frames. As can be seen in the illustration, the degree of transparency of the reference image is greater in FIG. 3C than it is in the earlier point in time FIG. 3B. Thus, the reference image may gradually fade from opaque to different degrees of semi-transparency, or one or more other characteristics may gradually change as the motion sequence progress. However, implementations of the present disclosure are not limited to gradual or continuous changes in the characteristics of the reference image, but may also include sudden changes in characteristics and may include sudden changes in the form or type of reference image.

One benefit to the example depicted in FIGS. 3A-3D is that it may combine beneficial features of both opaque reference images and semi-transparent reference images, e.g., as shown in FIGS. 1A-1D and 2A-2D, respectively. For example, an opaque reference image may provide a more dramatic 3D effect but may also more greatly obstruct the underlying contents 104 of the scene, while a semi-transparent reference image or other see-through reference image may provide a less dramatic effect but provide a clearer view of the scene contents 104. By initially flashing the reference image opaque, as shown in the illustrated example of FIGS. 3A-3D, the reference image may be more firmly implanted in the viewer's mind to impart a greater 3D illusion in the viewer's mind, even though it later transitions to a semi-transparent or see through nature.

Furthermore, in certain implementations, one or more characteristics of the reference image may change periodically. For example, the example process of FIG. 3A-3D may be repeated periodically so that the reference image periodically transitions to opaque and back to see through, in order to maintain a fixed reference in the viewer's mind without continuously obscuring elements in the scene. In implementations involving video games and certain other computer applications, a system may be further configured to time one or more transitions to coincide with the current state of the game or application or the contents of the scene. For example, the contents of a video game may contain certain points in time, such as cut scenes, menus selections, and the like, where obscuring elements may be less of a concern. In certain implementations, one or more characteristics of the reference image may be timed to coincide with certain points of the state of the application. For example, the reference image may be configured to transition from semi-transparent to opaque when the content of the scene matches certain pre-determined characteristics, e.g., when the content is a cut scene in a video game, between “plays” in a sports game, etc.

In the illustrated examples of FIGS. 1-3, the reference images have been depicted as a pair of two vertical columns. More specifically, the reference images of FIGS. 1-3 have been depicted as a pair of vertical rectangular bars, and, moreover, the rectangular bars have been depicted as continuous and extending the entire vertical height of the viewing window. In these examples, the vertical bars of the reference image may have the effect dividing the graphics into panels to create a polyptych effect on the images in each frame. Specifically, the use of two vertical bars extending the entire height of the graphics in the examples of FIGS. 1-3 generate a triptych effect (i.e., three panels) on the graphics, but other numbers of bars may generate other polyptych style graphics (other numbers of panels).

In certain implementations, it may be desirable to utilize a triptych or polyptych style frames because this results in a center panel and two or more side panels, and the center panel may be rendered as the main or primary panel of the viewport. For example, a graphics processing system may be configured to render the contents of the scene primarily in the center panel, and use the side panels for supplemental effect for enhancing a 3D illusion in accordance with aspects of the present disclosure.

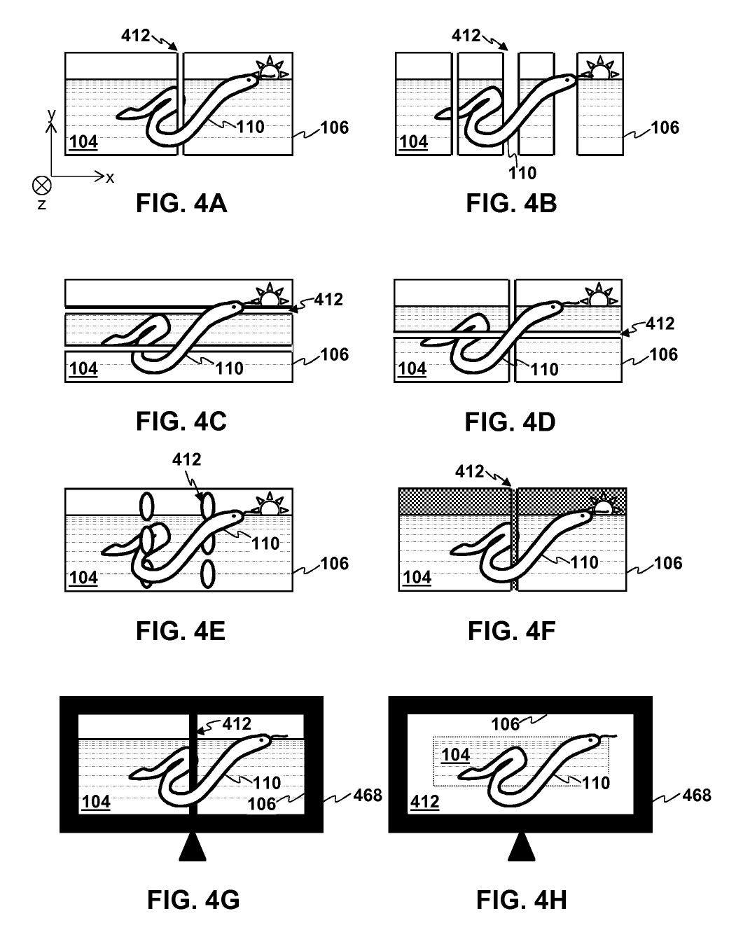

It is emphasized that many variations of the above described reference images are possible according to aspects of the present disclosure. While the reference image in the forgoing examples have been depicted as a pair of two vertical rectangular bars rendered onto the viewing window of the scene, implementations of the present disclosure may include other variations on the reference image. FIGS. 4A-4H depict various implementations of a reference image in accordance with aspects of the present disclosure.

As shown in FIGS. 4A and 4B, a reference image 412 may include any number of vertical bars. For example, the reference image may include any number of bars, such as a single bar as shown in FIG. 4A, three bars as shown in FIG. 4B, or some other number of bars. Moreover, where the reference image includes a plurality of discrete elements, such as a plurality of discrete bars as shown in FIG. 4B, it is possible to use difference dimensions on different elements of the reference image 412. For example, as shown in FIG. 4B, a reference image having bars of different widths may be used.

Furthermore, in certain implementations, the reference image may be defined to include different elements at different depths. For example, using FIG. 4B as an example, the leftmost bar may be defined at a deeper depth threshold than the rightmost bar, a perception that may be further enhanced by different widths of bars. As an object 110 of the 3D contents 104 moves in a depth direction during the motion sequence, the object may be sequentially rendered to occlude an additional one of the elements of the reference image as it gets closer and closer to the viewer, further enhancing an illusion of motion in a depth direction.

It is noted that vertical columns may have the benefit that they essentially align with the gravity reference of a typical scene and the gravity reference of the viewer, thereby providing a more natural experience for the viewer, but bars may be oriented in another manner in certain implementations of the present disclosure. FIG. 4C depicts an example where the reference image 412 is rendered as one or more horizontal bars.

Moreover, while the reference image of the forgoing examples have been depicted as continuous bars which extend across an entirely length of the image, other types of reference images may be fixed to a viewing window to enhance a 3D effect according to aspects of the present disclosure. For example, the reference image 412 may be rendered as both one or more horizontal and one or more vertical bars simultaneously, as shown in FIG. 4D, which depicts a reference image having a crisscross orientation with two or more bars that intersect one another. By way of further non-limiting example, the reference image may include vertical columns that are discontinuous and/or do not extend an entire length of the viewing window, such as in the example depicted in FIG. 4E, which depicts the reference image 412 as a plurality of dots fixed to the viewport 106. In the example depicted in FIG. 4E, the dots are arranged as a set of two vertical columns of dots.

In certain implementations of the present disclosure, color parameters or texture parameters of the reference image may be manipulated depending on a desired effect. For example, as shown in the example of FIG. 4F, color parameters and/or texture parameters of the reference image 412 may be rendered to correspond to one or more content elements of the underlying scene 104. In the example depicted in FIG. 4F, the reference image is rendered to match one or more elements of the underlying content 104. However, in certain implementations, it may be preferable to render the reference image in a manner the explicitly contrasts with the underlying content elements as much as possible, so that the reference image appears to the viewer as if it is outside of the world depicted by the underlying contents. Thus, for example, if the underlying scene is a night scene, the reference image may be rendered white or another light color to ensure it contrasts with the darkness of the scene, and, conversely, if it is a daytime scene, the reference image may be rendered to be black or another dark color to ensure that it contrasts with the brightness of the scene.

FIG. 4G depicts another implementation of the present disclosure in which the color of the reference image 412 is selected to match a display device 468, e.g., the color of the casing of the display device around the screen. This may be beneficial since it may better pull the reference image outside of the underlying virtual world 104 and into the viewer's world and the plane of the display screen. This may be accomplished in a variety of ways. For example, the color of the reference image may be selected to match a pre-determined color that is presumed to be the color of a display device. Since most conventional display devices may be presumed to be black or dark grey, the reference image may be rendered with a color that matches one of these colors. In other implementations, this may be accomplished by providing a user with a set of discrete user selectable choices which may include pre-determined display device colors so that the user may select the color that best matches the user's display.

FIG. 4H depicts another implementation of the present disclosure in which the color of the reference image 412 is in the form of a frame at a periphery of the viewing window 106 that contains the underlying content 104. In this example, the frame at the periphery of the viewing window is white and rectangular, although other colors and shapes may be used. The frame is configured so that portions of the object 110 that are in front of the frame in the image appear to emerge out of the viewing window 106 towards the viewer. It is noted that the reference image 412 in the form of a frame may be opaque, as it is depicted in the example illustrated in FIG. 4H, or it may be translucent or may otherwise blur the underlying content 104 as discussed above. While the example shown in FIG. 4H depicts a white reference image, a reference image 412 in the form of a frame may alternatively be colored to match the color of the edge of the display device, as discussed above.

It is also more generally noted that implementations of the present disclosure may include reference images that have one or more user selectable characteristics. Since the reference image may be rendered in an interactive graphics processing application, it can be automatically generated to correspond to different user preferences. For example, the user may be able to select a desired layout of the reference image (e.g., horizontal or vertical bars), number of discrete elements of the reference image (e.g., number of bars), size of elements in the reference image (e.g., thickness of bars), degree of transparency of the reference image, color of the reference image, texture of the reference image, depth of the reference image, some other characteristics, and any combination thereof.

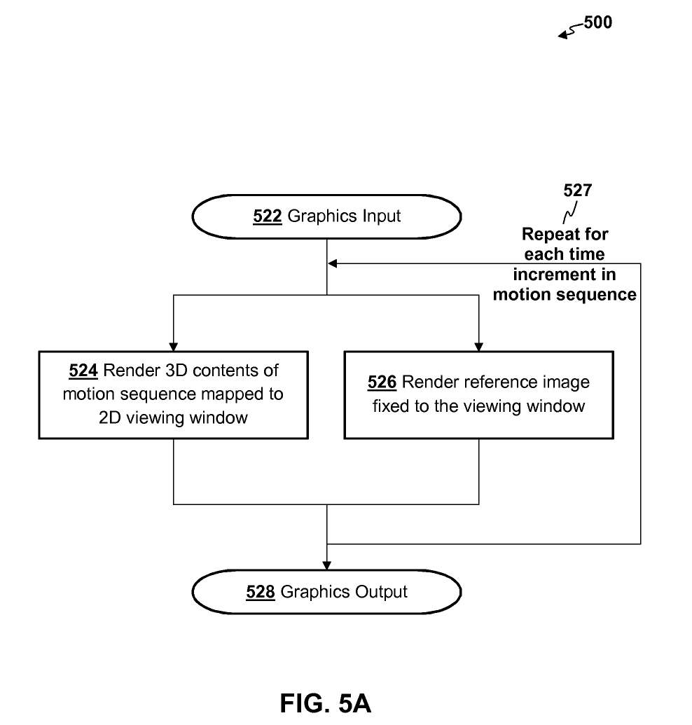

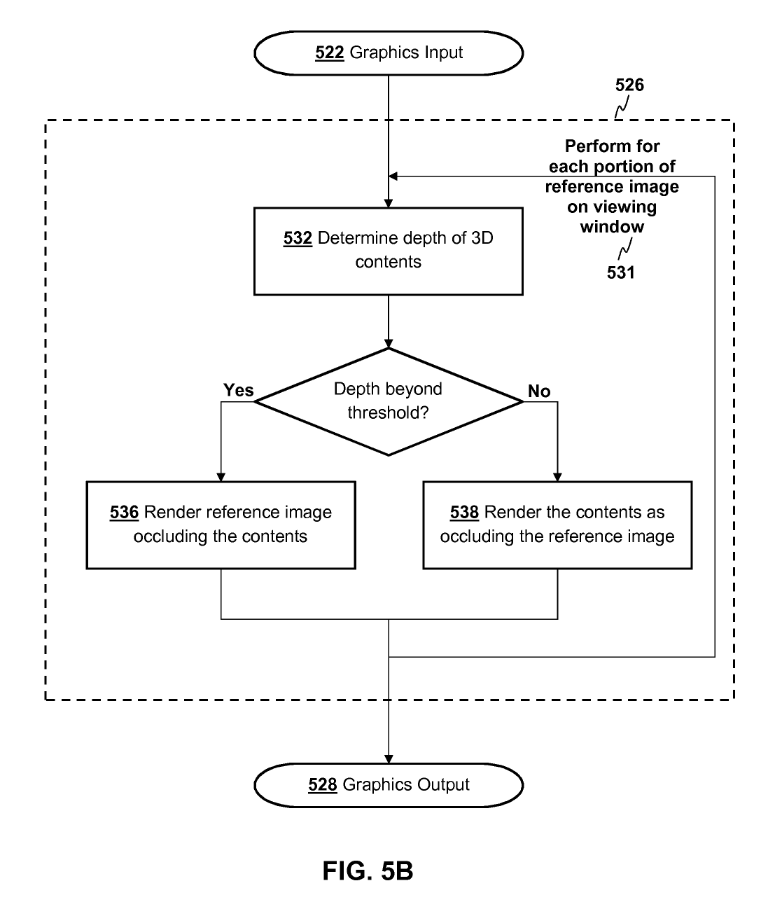

Turning now to FIGS. 5A-5B, a method 500 of rendering graphics is depicted according to certain implementations of the present disclosure. The illustrated method 500 may involve 3D graphics rendered for a two-dimensional screen of a display device, and the 3D graphics may be rendered with a reference image fixed to a two-dimensional viewing window in order to enhance an illusion of depth for the viewer in accordance with aspects of the present disclosure. The three-dimensional contents may depict a sequence of motion over time, and the graphics depicting the motion sequence and the reference image may be rendered in accordance with any of the techniques described herein, such as those examples described with reference to FIGS. 1-4.

As shown in FIG. 5A, the method 500 may include rendering three-dimensional contents mapped to a two-dimensional viewing window, as indicated at 524. The 3D contents rendered at 524 may depict a scene that includes sequence of motion over time. In certain implementations, the sequence of motion may correspond to an interactive application, such as a video game, and the 3D contents may be rendered in response to user inputs in real-time in order to visually depict the state of the game. The 3D contents may include 3D virtual objects in a virtual world.

The method 500 may also include rendering a reference image that is defined in fixed relation to the viewing window, as indicated at 526. The reference image may be separate from the 3D contents of the motion sequence, and may be rendered as either occluding the contents or being occluded by the 3D contents at portions of the viewing window, depending on the depth of the underlying contents at those portions of the viewing window where the reference image is defined.

The three-dimensional contents and the manner in which they are mapped to the viewing window may change over time during the motion sequence. Accordingly, the process depicted in FIG. 5A may be repeated iteratively for a plurality of increments of time during the sequence of motion, as indicated at 527. In certain implementations, the graphics may be rendered by a processing unit, e.g., a GPU, as a sequence of frames, and repeating the process iteratively at 527 may be accomplished by repeating the process for each new frame. The rendering of each new time increment or each new frame may be in response to graphics input 522, which may involve drawing commands issued by an application or game, e.g., draw calls through a graphics application programming interface (API). The graphics output 528 may include a sequence of rendered frames that together form a moving video depicting the sequence of motion, with the reference image enhancing the illusion of motion in the depth direction during the motion sequence.

In certain implementations, the method 500 depicted in FIGS. 5A-5B may be a real-time rendering method technique, in which the graphics output 528 is presented to a viewer on a display device in real-time as it is generated. In other implementations, the graphics may be rendered “offline” for later presentation to the viewer.

It is noted that many graphics processing techniques for video games operate on a tight budget, and adding in the 3D effect may cause frame rate drop if it is integrated into the graphics during live game play. Therefore, in some implementations, the reference image may be generated automatically by the system for display outside of core game play. For example, the motion sequence may be rendered for display as a highlight or cutscene to be displayed during stoppages in game play, e.g., between rounds, matches, sessions, and the like.

By way of example, and not by way of limitation, a shooter game may generate highlights so that users can watch particularly notable “kills”, or a sports game may generate highlights for particularly spectacular plays with the reference image added to the content based on information contained in a depth buffer. This may provide a way for highlights to be generated automatically with an enhanced 3D effect so that users may later watch the motion sequences without utilizing computational resources during in game play and triggering stuttering and other undesirable effects that might disrupt the playability of the game.

As the depth of the contents change over time, one or more objects of the 3D contents may transition between being occluding the reference image and being occluded by the reference image, in accordance with principles described above with respect to FIGS. 1-4, to create an enhanced illusion of 3D depth and motion of one or more objects in a depth direction. In certain implementations, this may be accomplished by checking the depths of content elements in a depth buffer and comparing them to a defined threshold of the reference image at the portion of the viewing window that corresponds to that content element.

Turning now to FIG. 5B, a more detailed illustration of rendering the reference image, as indicated at 526, is depicted. The method depicted in FIG. 5B is a more detailed depiction of how the reference image in particular scene may be rendered in the graphics rendering method depicted in FIG. 5A.

As shown in FIG. 5B, rendering the reference image may include determining a depth of the 3D contents, as indicated at 532, at a portion of the viewing window where the reference image is defined. Specifically, the reference image may correspond to one or more depth thresholds that define whether not the contents are rendered in front of or behind the reference image, and determining the depth at 532 may involve determining whether or not the depth of the 3D contents is beyond the depth threshold of the reference image at the portion of the viewing window. Determining the depth at 532 may involve checking a depth buffer contained in graphics memory to determine a depth value of the contents that are mapped to that portion of the viewing window.

If, at that portion of the viewing window, the depth of the contents is beyond the threshold, the reference image may be rendered as occluding the 3D contents at that portion of the viewing window, as indicated at 536. If, at that portion of the viewing window, the depth of the contents is instead not beyond the threshold, the contents may be rendered as occluding the reference image at that portion of the viewing window, as indicated at 538.

It is noted that different portions, e.g., different X-Y coordinates, of the viewing window may correspond to different depths of the contents. For example, as shown in FIG. 1D, the 3D contents 104 include a snake 110, and a portion of the snake, e.g., its tail portion, is beyond a depth threshold, while a portion of the snake, e.g., its head portion, is not beyond the threshold. Accordingly, to better simulate the illusion of depth across the area of the viewing window, e.g., across all X-Y coordinate positions of the viewing window containing the reference image, the process depicted in FIG. 5B may be performed similarly for a plurality of different portions of the viewing window where the reference image is defined, as indicated at 531.

Specifically, the reference image may be pre-defined at one or more portions of the viewing window that collectively make up a subset of the total area of the viewing window. The portions may collectively make up different shapes depending on the particular implementation, e.g., the portions may collectively define one or more vertical bars as shown in FIGS. 1-3, a frame at the periphery of the viewing window, as shown in FIG. 4H, or another shape. The process depicted in FIG. 5B may be performed for each of those subdivisions of the reference image, e.g., each portion of the viewing window where the reference image is defined, in order to account for different depths of the 3D contents mapped to different 2D positions of the viewing window.

It is noted that one or more different repetitions within a given time increment may be performed in parallel, for example, using parallel processing of a GPU. In certain implementations, these subdivisions may correspond to each pixel of the viewing window where the reference image is defined, and the process may be performed for each pixel based on corresponding pixel depth values of the underlying contents contained in a depth buffer (Z-buffer). Furthermore, in certain implementations, this may be accomplished by rendering the reference image pixels with a pixel shader, where the corresponding pixel depth value in the depth buffer at each pixel determines whether or not the reference image pixel is rendered at that pixel, i.e., whether the reference image is rendered as occluding the contents as indicated at 536, or wherein the reference image pixel is omitted and the contents are rendered as occluding the reference image as indicated at 538.

In certain implementations, the reference image may have a depth threshold that is uniformly defined, e.g., the depth threshold is the same across each iteration at 531, within a given time increment or within a given frame. In other words, the depth threshold may be spatially uniform so that different spatial locations of the reference image on the viewing window have the depth threshold defined at the same depth.

However, in certain implementations, the depth threshold may be non-uniformly defined and have a depth threshold defined differently at different respective spatial portions of the viewing window, causing the depth threshold to change across different iterations at 531 within a given time increment or within a given frame of the motion sequence. For example, in certain implementations, the reference image may include a plurality of vertical bars, and each bar may contain a different depth threshold.

Moreover, other characteristics of the reference image may be non-uniformly defined, such that they change at different spatial locations and different iterations at 531 utilize a different reference image parameter. For example, the reference image may be rendered with a color or transparency that is different at different spatial locations of the reference image within a given time increment, such that one or more parameters of the reference image change at different repetitions of 531. For example, the color of the reference image may be rendered so that those portions of the viewing window that are closer to the edges of the viewing window better match a display device casing, e.g., by utilizing a reference image with a spatial gradient that blends into the color of the display device (e.g., black) at the edges of the viewing window.

It is noted that the method depicted in FIGS. 5A-5B may be performed using any computer graphics processing technique, such as raster based polygon rendering, ray tracing, ray casting, and the like. However, due to the computational cost associated with techniques such as ray tracing, most rendering tasks where speed and latency is a chief concern, such as video gaming applications, utilize raster graphics rendering based on polygons, where the 3D contents are represented by a plurality of triangles or other primitives oriented in 3D space, and these contents are rasterized to project them onto a 2D viewing window.

In certain implementations of the present disclosure, graphics may be rendered with a reference image attached to the viewing window using a raster graphics processing pipeline by uniquely leveraging certain aspects of the rendering pipeline.

For one, since pixel (or fragment) depth information is typically contained in a depth buffer for z-culling purposes and hidden surface removal, the depth of the contents of any given pixel of the viewing window can be readily determined from the depth buffer for purposes of rendering the reference image based on the depth of the contents in the scene. For another, since programmable pixel shaders are often used to manipulate parameters of the image on a per-pixel basis, utilizing a pixel shader to render a reference image provides an intuitive way to fix the reference image to the viewing window of rendered graphics, regardless of the underlying contents that are mapped to the viewing window. For example, for any given frame, a subset of the pixels in the frame may be defined as the reference image, e.g., a subset of pixels that corresponds to one or more vertical columns in a rectangular pixel array, and these pixels may be defined as the reference image to render a reference image for the viewer that is fixed to the viewing window of a sequence of motion. Thus a pixel shader may be able to easily render each defined reference image pixel in the subset based on the respective pixel depth values contained in the depth buffer, pixel by pixel. This may allow a graphics processing system to automatically generate enhanced 3D GIF style graphics on the fly, without prior knowledge of the contents of the scene.

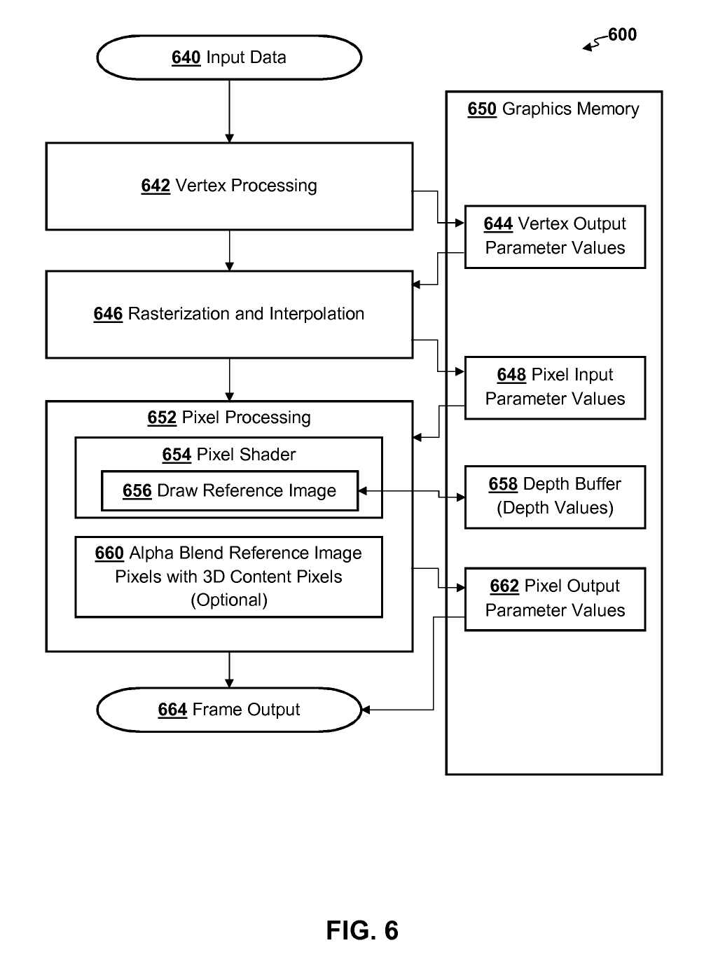

FIG. 6 depicts an illustrative method 600 of rendering graphics with a reference image using raster graphics pipeline according to aspects of the present disclosure. The method 600 is an implementation of the method 500 depicted in FIGS. 5A-5B. In the implementation 600, the graphics may be mapped to a two-dimensional viewing window using rasterization and interpolation of processed vertex parameter values to project the 3D contents onto a two-dimensional viewing window defined by an array of pixel values, or fragments. In the illustrative example of FIG. 6, the reference image may be rendered at a pixel processing stage of the pipeline based on pixel depth values contained in a depth buffer. It is noted that the illustrated diagram of FIG. 6 is a simplified schematic to highlight certain aspects of the present disclosure, and may optionally include many other conventional stages in a graphics rendering pipeline, such as geometry and tessellation shaders/processing, scissor tests, z-culling, and the like.

The method 600 may be implemented by a processing unit, such as a GPU, that may be configured to implement programmable shaders to render graphics in coordination with an application. The graphics may be rendered as a series of frames based on drawing commands or draw calls which provide certain input data 640 to the rendering pipeline. Each rendered frame may depict three-dimensional contents that may be represented as a plurality of triangles or other primitives oriented in three-dimensional space. Throughout the graphics processing method 600, a processing unit may be configured to manipulate values contained in graphics memory 650, and the graphics memory 650 may include a variety of buffers, such as vertex buffers, index buffers, depth buffers, front and back framebuffers, and the like for temporarily storing graphics data throughout the rendering pipeline.

Broadly speaking, the method 600 may include the general stages of vertex processing 642, rasterization/interpolation 646, and pixel processing 652, as shown in the illustration of FIG. 6.

The vertex processing stage, as indicated at 642, may include the manipulation of parameter values of the vertices of the primitives (e.g., triangles) making up the 3D contents of the scene. Some portion of the vertex processing may be performed by one or more vertex shader programs that may be configured to be executed by a GPU or other processing unit. The vertex processing 642 may also optionally involve other shaders, such as tessellation shaders to subdivide one or more primitives and/or geometry shaders, to generate new primitives. When all vertex processing is completed, each vertex may be defined by one or more vertex output parameter values 644 in the memory 650, as shown in FIG. 6. These parameter values may include positions, colors, texture coordinates, lighting, and the like for each vertex in the frame.

These primitives and their corresponding vertices that make up the 3D contents of the frame may then be mapped to a two-dimensional viewing window by rasterizing and interpolating the vertices and their corresponding parameter values, as indicated at 646, to map them to a set of discrete pixels, e.g., in a rectangular array. The process of rasterization and interpolation may map the 3D contents onto a two-dimensional viewing window plane through a process that essentially projects these contents onto the image plane of the scene.

The interpolated vertex parameter values for each pixel may correspond to a set of input pixel parameter values 648 stored in the graphics memory 650 for each pixel. In the illustrated example, the input pixel parameter values 648 may correspond to only those pixel values of the underlying contents, since the reference image has not yet been rendered yet in this example. These pixels and pixel parameter values may be input into what is generally designated as a pixel processing stage 652 in FIG. 6.

The pixel processing may receive the input pixel parameter values 648 and perform various operations to modify pixel parameter values associated with one or more of the pixels. This may include further rendering of the 3D contents of the scene on a per-pixel basis. This may also include the rendering of a reference image, as indicated at 656, to enhance an illusion of depth in accordance with aspects of the present disclosure.

In the illustrated implementation, at least a portion of the pixel processing 652 includes pixel shader operations 654 performed by one or more programmable pixel shaders. Moreover, in the illustrated example, the reference image may be drawn during the pixel shader operations 654 based on pixel depth values 658 of the scene contents contained in the graphics memory 650.

The reference image may be defined in fixed relation to the viewing window by being defined as a particular subset of the pixels in each frame that is less than the total number of pixels in the viewing window. For example, a subset of pixels that correspond to one or more vertical columns in the array of pixels may be defined as the reference image. For each pixel defined to contain the reference image, the pixel shader 654 may be configured to check the depth value 658 of the contents mapped to that pixel. If the depth is beyond some defined threshold for that pixel, the pixel shader may be configured to draw a reference image pixel at that pixel to occlude the scene contents at the pixel. If the depth is not beyond the threshold at that pixel, the pixel shader may omit any drawing of the reference image for that pixel so that the underlying scene contents occlude the reference image.

It is noted that the depth threshold for the reference image may be defined in a variety of ways. In certain implementations, a particular depth may be pre-defined by a developer of a program which renders the graphics. In other implementations, the system may be configured to monitor depth values over time, e.g., by monitoring changes in depth values contained in a depth buffer, to determine where content elements in the scene are located in a depth direction. The system may then be configured to define the depth threshold based on some pre-determined criteria that will ensure that one or more objects are likely to cross the defined depth threshold defined for the reference image as the sequence of motion progresses. For example, a depth threshold of the reference image may be defined to be an average depth value of the content in a depth buffer observed over some period of time, or may be defined at any depth value that is within a range of depth values observed during some period of time.

The manner in which the reference image is drawn at 656 may depend on the nature of the reference image for that implementation. If the reference image is opaque for a given pixel in a given frame, then where the reference image is occluding the underlying scene contents (i.e., the depth value of the contents is beyond the threshold at that pixel) the pixel values of the underlying contents may simply be discarded and replaced with the reference image pixel parameter values. For example, each pixel in the viewing window where the reference image is defined and the scene contents are beyond the threshold may be replaced by a solid black pixel to render a black opaque reference image.

Alternatively, if the reference image is semitransparent for a given pixel in a given frame, then where the reference image is occluding the underlying scene contents (i.e., the depth value of the contents is beyond the threshold at that pixel) the reference image pixel may be rendered by storing the reference image pixel parameter values to the graphics memory without discarding the underlying content pixel values. Then, as shown at 660, the reference image pixel may be alpha blended with the underlying content pixel so that the occluding reference image is rendered as semitransparent and permits the occluded scene contents to be partially visible through the reference image. For example, in certain implementations, an alpha blend value of between 0 and 1 (but not 0 or 1) may correspond to a semitransparent reference image, whereas an alpha blend value of 0 or 1 would correspond to complete occlusion of the content pixel by the reference image without the occluded element being partially visible.

The pixel processing 652 may perform operations for each pixel in the frame, and the pixel shader may draw the reference image 656 based on the pixel depth values in the depth buffer 658 for the pixels of the viewing window where the reference image is defined. When all of the parameter values of each pixel have been determined, the pixel output parameter values 662 may correspond to the pixels of the final frame for display, which may be contained in a frame buffer of the graphics memory 650. Each final frame may correspond to the output of the rendering pipeline 664, and the process may be repeated for each frame in the motion sequence.

It is noted that various steps contained in the graphics rendering pipeline depicted in FIG. 6 may be performed by modules that may be implemented in hardware, software, or a combination thereof. In the illustration of FIG. 6, the reference image module is at least partially implemented in software via a programmable pixel shader, which may provide additional flexibility for the reference image characteristics to be tailored to particular applications by a programmer or developer. However, in certain implementations, the reference image module or a portion thereof may be embodied in hardware, e.g., through one or more specialized circuits such as an FPGA or ASIC.

Moreover, while the illustrated example of FIG. 6 implements the reference image module at a pixel processing stage of the rendering pipeline, certain implementations of the present disclosure may implement the reference image at another stage in the rendering pipeline. For example, in certain implementations the reference image may be generated earlier, such as one or more primitives defined in fixed relation to the viewing window. However, it is noted that the reference image is easier to fix to the viewing window in implementations where the reference module operates at a pixel processing stage, since the viewing window is itself essentially defined by the array of pixels.

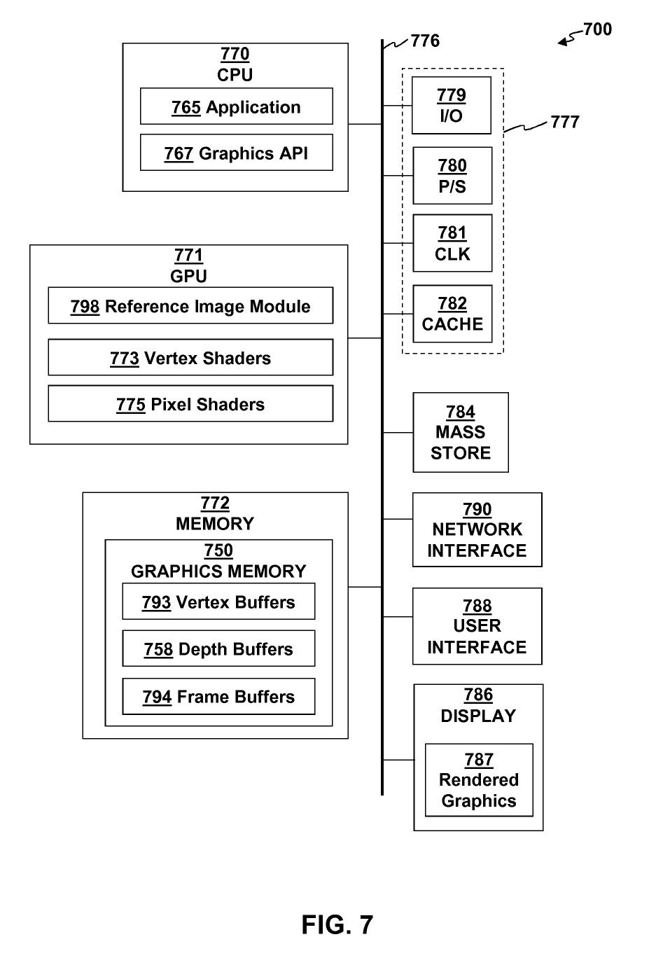

Turning now to FIG. 7, an illustrative example of a computing system 700 that is configured to render graphics in accordance with aspects of the present disclosure is depicted. The system 700 may be configured to render graphics for an application 765 with an enhanced 3D illusion by both rendering the underlying contents defined by the application, as well as rendering a reference image based on depth values contained in a depth buffer. According to aspects of the present disclosure, the system 700 may be an embedded system, mobile phone, personal computer, tablet computer, portable game device, workstation, game console, and the like.

The system may generally include a processor and a memory configured to implement aspects of the present disclosure, e.g., by performing a method having features in common with the method of FIG. 5A-5B or FIG. 6. In the illustrated implementation of FIG. 7, the system 700 includes a central processor unit (CPU) 770, a graphics processor unit (GPU) 771, and a memory 772, and the memory may optionally be accessible to both the CPU and GPU. The CPU 770 and GPU 771 may each include one or more processor cores, e.g., a single core, two cores, four cores, eight cores, or more. The memory 772 may include one or more memory units in the form of integrated circuits that provides addressable memory, e.g., RAM, DRAM, and the like.

By way of example, and not by way of limitation, the CPU 770 and GPU 771 may access the memory 772 using a data bus 776. In some cases, it may be useful for the system 700 to include two or more different buses. The memory 772 may include graphics memory 750 that may store graphics resources and temporarily store buffers of data for a graphics rendering pipeline, which may include, e.g., one or more vertex buffers 793 for storing vertex parameter values, one or more depth buffers 758 for storing depth values of graphics content, and one or more frame buffers 794 for storing completed frames to be sent to a display.

The CPU may be configured to execute CPU code, which may include an application 765 utilizing rendered graphics (such as a video game) and a graphics API 767 for issuing draw commands or draw calls to programs implemented by the GPU 771 based on the state of the application 765. The CPU code may also implement physics simulations and other functions.

The GPU may be configured to operate as discussed above with respect illustrative implementations of the present disclosure. The GPU 771 may be configured to render the three-dimensional contents of the application as mapped to a viewing window. The GPU 771 may also be configured to implement a reference image module 798 to render a reference image in fixed relation to the viewing window that provides an enhanced illusion of depth during a motion sequence of the underlying contents of the application 765. To support the rendering of graphics, the GPU may execute GPU code, which may include one or more vertex shaders 773 and/or one or more pixel shaders 775, as discussed above. The GPU may also execute other programs, such as, e.g., geometry shaders, tessellation shaders, compute shaders, and the like. In certain implementations, the reference image module 798 may be at least partially embodied in a non-transitory computer readable medium as programming in the pixel shader 775 to render a reference image on a per-pixel basis based on information contained in the depth buffer 758. The shaders may interface with data in the memory 750 and the pixel shaders may output rendered pixels in the frame buffer 794 for temporary storage before being output to a display.

The system 700 may also include well-known support functions 777, which may communicate with other components of the system, e.g., via the bus 776. Such support functions may include, but are not limited to, input/output (I/O) elements 779, power supplies (P/S) 780, a clock (CLK) 781, and a cache 782. The apparatus 700 may optionally include a mass storage device 784 such as a disk drive, CD-ROM drive, flash memory, tape drive, Blu-ray drive, or the like to store programs and/or data. The device 700 may also include a display unit 786 to present rendered graphics 787 to a user and user interface unit 788 to facilitate interaction between the apparatus 700 and a user. The display unit 786 may be in the form of a flat panel display, cathode ray tube (CRT) screen, touch screen, or other device that can display text, numerals, graphical symbols or images. The display 786 may display rendered images 787 processed in accordance with various techniques described herein. The user interface 788 may include one or more peripherals, such as a keyboard, mouse, joystick, light pen, game controller, touch screen, and/or other device that may be used in conjunction with a graphical user interface (GUI). In certain implementations, the state of the application 765 and the underlying content of the graphics that are mapped to the viewing window may be determined at least in part by user input through the user interface 788.

The system 700 may also include a network interface 790 to enable the device to communicate with other devices over a network. The network may be, e.g., a local area network (LAN), a wide area network such as the internet, a personal area network, such as a Bluetooth network or other type of network. Various ones of the components shown and described may be implemented in hardware, software, or firmware, or some combination of two or more of these.

### Additional Aspects of the Disclosure

It will be appreciated from the forgoing that aspects of the present disclosure include a first method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold by checking a depth value of the content contained in a depth buffer, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold.

In accordance with additional aspects of the first method, the sequence of motion includes a plurality of time increments, a) and b) are repeated for each said time increment, the one or more portions is a plurality of portions, and, within each said time increment, i), ii), and iii) are repeated for each said portion.

In accordance with additional aspects of the first method, the sequence of motion includes a plurality of frames, a) and b) are repeated for each said frame, the one or more portions is a plurality of pixels, and, within each said frame, i), ii), and iii) are repeated for each said pixel.

In accordance with additional aspects of the first method, the one or more portions collectively define one or more vertical columns of the viewing window. In some implementations, the vertical columns are rectangular bars. In some implementations, the rectangular bars extend an entire height of the viewing window.

In accordance with additional aspects of the first method, the one or more portions collectively define a frame at a periphery of the viewing window.

In accordance with additional aspects of the first method, a pixel shader performs said rendering the reference image in b).

In accordance with additional aspects of the first method, said occluding the content in ii) includes rendering the reference image as partially see-through so that the content occluded by the reference image is partially visible. In some implementations, said rendering the reference image as partially see-through includes alpha blending parameter values of the content with parameter values of the reference image.

In accordance with additional aspects of the first method, the sequence of motion includes a plurality of frames, a) and b) are repeated for each said frame by a GPU, the one or more portions is a plurality of pixels, and, within each said frame, i), ii), and iii) are repeated for each said pixel by a pixel shader executed by the GPU. In some implementations, said occluding the content with the reference image in ii) includes rendering an opaque reference image pixel by discarding pixel parameter values of the content and replacing them with reference image pixel parameter values. In some implementations, said occluding the content with the reference image in ii) includes rendering a semi-transparent reference image pixel by alpha blending pixel parameter values of the content with reference image pixel parameter values.

In accordance with additional aspects of the first method, said rendering the reference image in b) comprises rendering the reference image in a color that matches a display device casing.

In accordance with additional aspects of the first method, the three-dimensional content is game play footage of an interactive video game. In some implementations, said rendering the reference image in b) comprises rendering the reference image in real-time during game play.

In accordance with additional aspects of the first method, the sequence of motion includes a plurality of time increments, a) and b) are repeated for each said time increment, the one or more portions is a plurality of portions, and, within each said time increment, i), ii), and iii) are repeated for each said portion, wherein said rendering the reference image in b) comprises rendering the reference image with one or more different sets of parameters at one or more different respective repetitions of b), such that the parameters of the reference image are dynamic over time across the sequence of motion. In some implementations, said rendering the reference image in b) comprises rendering the reference image with identical sets of parameters at each different respective repetition of b), such that the parameters of the reference image are static over time across the sequence of motion. In some implementations, within each said time increment, said occluding the content with the reference image in ii) comprises rendering the given portion of the reference image with one or more different parameters at one or more different respective repetitions of ii), such that the parameters of the reference image are spatially non-uniform across the viewing window. In some implementations, within each said time increment, said occluding the content with the reference image in ii) comprises rendering the given portion of the reference image with identical parameters each different respective repetition of ii), such that the parameters of the reference image are spatially uniform across the viewing window.

In accordance with additional aspects of the first method, the three-dimensional content is game play footage of an interactive video game, the sequence of motion includes a plurality of frames, a) and b) are repeated for each said frame, the one or more portions is a plurality of pixels which collectively define one or more vertical columns of the viewing window, and, within each said frame, i), ii), and iii) are repeated for each said pixel by a pixel shader.

Additional aspects of the present disclosure include a first system comprising: at least one processor, and at least one memory, wherein the at least one processor is configured to execute an application having three-dimensional graphics content that depicts a sequence of motion, wherein the processor is configured to perform a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold by checking a depth value of the content contained in a depth buffer in the memory, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold.

In accordance with additional aspects of the first system, the at least one processor includes a central processing unit (CPU) and a graphics processing unit (GPU), wherein the CPU is configured to execute the application, and wherein the GPU is configured to perform the method of rendering graphics.

In accordance with additional aspects of the first system, the system further comprises a display device, wherein the method further comprises presenting the graphics on the display device.

In accordance with additional aspects of the first system, the system further comprises a pixel shader contained in the memory, wherein the pixel shader performs said rendering the reference image in b). In some implementations, the sequence of motion includes a plurality of frames, a) and b) are repeated for each said frame, the one or more portions is a plurality of pixels, and, within each said frame, i), ii), and iii) are repeated for each said pixel by a pixel shader executed by the processor.

In accordance with additional aspects of the first system, the application is an interactive video game, and the three-dimensional content is game play footage of the interactive video game. In some implementations, said rendering the reference image in b) comprises rendering the reference image in real-time during game play.

In accordance with additional aspects of the first system, the system further comprises a pixel shader contained in the memory, the at least one processor includes a central processing unit (CPU) and a graphics processing unit (GPU), the CPU is configured to execute the application, the GPU is configured to perform the method of rendering graphics, the application is an interactive video game, the three-dimensional content is game play footage of the interactive video game, the sequence of motion includes a plurality of frames, a) and b) are repeated for each said frame, the one or more portions is a plurality of pixels defining one or more vertical columns of the viewing window, and, within each said frame, i), ii), and iii) are repeated for each said pixel by the pixel shader executed by the GPU.

Additional aspects of the present disclosure include a first non-transitory computer readable medium having processor-executable instructions embodied therein, wherein execution of the instructions by a processor causes the processor to implement a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold by checking a depth value of the content contained in a depth buffer, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold.

Aspects of the present disclosure include a second method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold by rendering the reference image as partially see-through so that the content occluded by the reference image is partially visible, and iii) occluding the reference image with the content mapped to the given portion when it is determined in i) that the depth of the content mapped to the given portion is not beyond the depth threshold.

Additional aspects of the present disclosure include a second system comprising: at least one processor, and at least one memory, wherein the at least one processor is configured to execute an application having three-dimensional graphics content that depicts a sequence of motion, wherein the processor is configured to perform a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold by rendering the reference image as partially see-through so that the content occluded by the reference image is partially visible, and iii) occluding the reference image with the content mapped to the given portion when it is determined in i) that the depth of the content mapped to the given portion is not beyond the depth threshold.

Additional aspects of the present disclosure include a second non-transitory computer readable medium having processor-executable instructions embodied therein, wherein execution of the instructions by a processor causes the processor to implement a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold by rendering the reference image as partially see-through so that the content occluded by the reference image is partially visible, and iii) occluding the reference image with the content mapped to the given portion when it is determined in i) that the depth of the content mapped to the given portion is not beyond the depth threshold.

Aspects of the present disclosure include a third method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold, wherein the sequence of motion includes a plurality of time increments, wherein a) and b) are repeated for each said time increment, wherein the one or more portions is a plurality of portions, and, within each said time increment, i), ii), and iii) are repeated for each said portion, and wherein said rendering the reference image in b) comprises rendering the reference image with one or more different sets of parameters at one or more different respective repetitions of b), such that the parameters of the reference image are dynamic over time across the sequence of motion.

Additional aspects of the present disclosure include a third system comprising: at least one processor, and at least one memory, wherein the at least one processor is configured to execute an application having three-dimensional graphics content that depicts a sequence of motion, wherein the processor is configured to perform a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold, wherein the sequence of motion includes a plurality of time increments, wherein a) and b) are repeated for each said time increment, wherein the one or more portions is a plurality of portions, and, within each said time increment, i), ii), and iii) are repeated for each said portion, and wherein said rendering the reference image in b) comprises rendering the reference image with one or more different sets of parameters at one or more different respective repetitions of b), such that the parameters of the reference image are dynamic over time across the sequence of motion.

Additional aspects of the present disclosure include a third non-transitory computer readable medium having processor-executable instructions embodied therein, wherein execution of the instructions by a processor causes the processor to implement a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold, wherein the sequence of motion includes a plurality of time increments, wherein a) and b) are repeated for each said time increment, wherein the one or more portions is a plurality of portions, and, within each said time increment, i), ii), and iii) are repeated for each said portion, and wherein said rendering the reference image in b) comprises rendering the reference image with one or more different sets of parameters at one or more different respective repetitions of b), such that the parameters of the reference image are dynamic over time across the sequence of motion.

Aspects of the present disclosure include a fourth method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold, wherein the sequence of motion includes a plurality of time increments, wherein a) and b) are repeated for each said time increment, wherein the one or more portions is a plurality of portions, and, within each said time increment, i), ii), and iii) are repeated for each said portion, and, within each said time increment, said occluding the content with the reference image in ii) comprises rendering the portion of the reference image with one or more different parameters at one or more different repetitions of ii), such that the parameters of the reference image are spatially non-uniform across the viewing window.

Additional aspects of the present disclosure include a fourth system comprising: at least one processor, and at least one memory, wherein the at least one processor is configured to execute an application having three-dimensional graphics content that depicts a sequence of motion, wherein the processor is configured to perform a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold, wherein the sequence of motion includes a plurality of time increments, wherein a) and b) are repeated for each said time increment, wherein the one or more portions is a plurality of portions, and, within each said time increment, i), ii), and iii) are repeated for each said portion, and, within each said time increment, said occluding the content with the reference image in ii) comprises rendering the portion of the reference image with one or more different parameters at one or more different repetitions of ii), such that the parameters of the reference image are spatially non-uniform across the viewing window.

Additional aspects of the present disclosure include a fourth non-transitory computer readable medium having processor-executable instructions embodied therein, wherein execution of the instructions by a processor causes the processor to implement a method of rendering graphics, the graphics including three-dimensional content depicting a sequence of motion, the method comprising: a) rendering the three-dimensional content as mapped to a two-dimensional viewing window; and b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions: i) determining whether a depth of the three-dimensional content mapped to the given portion is beyond a depth threshold, ii) occluding the content mapped to the given portion with the reference image when it is determined in i) that the depth of the content mapped to the given portion is beyond the depth threshold, and iii) occluding the reference image with the content mapped to the given portion when it is determined in i) that the depth of the content mapped to the given portion is not beyond the depth threshold, wherein the sequence of motion includes a plurality of time increments, wherein a) and b) are repeated for each said time increment, wherein the one or more portions is a plurality of portions, and, within each said time increment, i), ii), and iii) are repeated for each said portion, and, within each said time increment, said occluding the content with the reference image in ii) comprises rendering the portion of the reference image with one or more different parameters at one or more different repetitions of ii), such that the parameters of the reference image are spatially non-uniform across the viewing window.

Additional aspects of the present disclosure include an electromagnetic or other signal carrying computer-readable instructions for performing the foregoing first method, the foregoing second method, the forgoing third method, or the forgoing fourth method.

Additional aspects of the present disclosure include a computer program product downloadable from a communication network and/or stored on a computer-readable and/or microprocessor-executable medium, characterized in that it comprises program code instructions for implementing the foregoing first method, the foregoing second method, the forgoing third method, or the forgoing fourth method.

It is understood that various modifications and combinations of the above mentioned aspects are within the scope of the present disclosure. For example, any of the aspects of the above-mentioned first method may be incorporated into any of the other mentioned methods, including the above mentioned second method, the third method, and the fourth method. By way of further example, any aspects of the above-mentioned methods may be incorporated into the above-mentioned systems and computer-readable mediums.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “a”, or “an” refers to a quantity of one or more of the item following the article, except where expressly stated otherwise. The appended claims are not to be interpreted as including means-or-step-plus-function limitations, unless such a limitation is explicitly recited in a given claim using the phrase “means for.”

What is claimed is:

1. A method of rendering graphics, the graphics including three-dimensional content depicting a sequence of motion, the method comprising:
a) rendering the three-dimensional content as mapped to a two-dimensional viewing window; and
b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions:
i) determining whether a depth of the three-dimensional content mapped to the given portion is beyond a depth threshold by checking a depth value of the content contained in a depth buffer,
ii) occluding the content mapped to the given portion with the reference image when it is determined in i) that the depth of the content mapped to the given portion is beyond the depth threshold, and
iii) occluding the reference image with the content mapped to the given portion when it is determined in i) that the depth of the content mapped to the given portion is not beyond the depth threshold.

2. The method of claim 1,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion.

3. The method of claim 1,
wherein the sequence of motion includes a plurality of frames,
wherein a) and b) are repeated for each said frame,
wherein the one or more portions is a plurality of portions,
wherein each said portion is a pixel,
wherein, within each said frame, i), ii), and iii) are repeated for each said pixel.

4. The method of claim 1,
wherein the one or more portions collectively define one or more vertical columns of the viewing window.

5. The method of claim 1,
wherein the one or more portions collectively define one or more vertical columns of the viewing window,
wherein each said vertical column is a rectangular bar.

6. The method of claim 1,
wherein the one or more portions collectively define one or more vertical columns of the viewing window,
wherein each said vertical column is a rectangular bar that extends an entire height of the viewing window.

7. The method of claim 1,
wherein the one or more portions collectively define a frame at a periphery of the viewing window.

8. The method of claim 1,
wherein a pixel shader performs said rendering the reference image in b).

9. The method of claim 1,
wherein said occluding the content in ii) includes rendering the reference image as partially see-through so that the content occluded by the reference image is partially visible.

10. The method of claim 1,
wherein said occluding the content in ii) includes rendering the reference image as partially see-through so that the content occluded by the reference image is partially visible,
wherein said rendering the reference image as partially see-through includes alpha blending parameter values of the content with parameter values of the reference image.

11. The method of claim 1,
wherein the sequence of motion includes a plurality of frames,
wherein a) and b) are repeated for each said frame by a GPU,
wherein the one or more portions is a plurality of portions,
wherein each said portion is a pixel,
wherein, within each said frame, i), ii), and iii) are repeated for each said pixel by a pixel shader executed by the GPU.

12. The method of claim 1,
wherein the sequence of motion includes a plurality of frames,
wherein a) and b) are repeated for each said frame by a GPU,
wherein the one or more portions is a plurality of portions,
wherein each said portion is a pixel,
wherein, within each said frame, i), ii), and iii) are repeated for each said pixel by a pixel shader executed by the GPU,
wherein said occluding the content with the reference image in ii) includes rendering an opaque reference image pixel by discarding pixel parameter values of the content and replacing them with reference image pixel parameter values.

13. The method of claim 1,
wherein the sequence of motion includes a plurality of frames,
wherein a) and b) are repeated for each said frame by a GPU,
wherein the one or more portions is a plurality of portions,
wherein each said portion is a pixel,
wherein, within each said frame, i), ii), and iii) are repeated for each said pixel by a pixel shader executed by the GPU,
wherein said occluding the content with the reference image in ii) includes rendering a semi-transparent reference image pixel by alpha blending pixel parameter values of the content with reference image pixel parameter values.

14. The method of claim 1,
wherein said rendering the reference image in b) comprises rendering the reference image in a color that matches a display device casing.

15. The method of claim 1,
wherein the three-dimensional content is game play footage of an interactive video game.

16. The method of claim 1,
wherein the three-dimensional content is game play footage of an interactive video game,
wherein said rendering the reference image in b) comprises rendering the reference image in real-time during game play.

17. The method of claim 1,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein said rendering the reference image in b) comprises rendering the reference image with one or more different sets of parameters at one or more different respective repetitions of b), such that the parameters of the reference image are dynamic over time across the sequence of motion.

18. The method of claim 1,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein said rendering the reference image in b) comprises rendering the reference image with identical sets of parameters at each different respective repetition of b), such that the parameters of the reference image are static over time across the sequence of motion.

19. The method of claim 1,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein, within each said time increment, said occluding the content with the reference image in ii) comprises rendering the given portion of the reference image with one or more different parameters at one or more different respective repetitions of ii), such that the parameters of the reference image are spatially non-uniform across the viewing window.

20. The method of claim 1,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein, within each said time increment, said occluding the content with the reference image in ii) comprises rendering the given portion of the reference image with identical parameters each different respective repetition of ii), such that the parameters of the reference image are spatially uniform across the viewing window.

21. The method of claim 1,
wherein the three-dimensional content is game play footage of an interactive video game,
wherein the sequence of motion includes a plurality of frames,
wherein a) and b) are repeated for each said frame,
wherein the one or more portions is a plurality of pixels that collectively define one or more vertical columns of the viewing window,
wherein, within each said frame, i), ii), and iii) are repeated for each said pixel by a pixel shader.

22. A system comprising:
at least one processor, and
at least one memory,
wherein the at least one processor is configured to execute an application having three-dimensional graphics content that depicts a sequence of motion,
wherein the processor is configured to perform a method of rendering graphics, the graphics including three-dimensional content depicting a sequence of motion, the method comprising:
a) rendering the three-dimensional content as mapped to a two-dimensional viewing window; and
b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions:
i) determining whether a depth of the three-dimensional content mapped to the given portion is beyond a depth threshold by checking a depth value of the content contained in a depth buffer in the memory,
ii) occluding the content mapped to the given portion with the reference image when it is determined in i) that the depth of the content mapped to the given portion is beyond the depth threshold, and
iii) occluding the reference image with the content mapped to the given portion when it is determined in i) that the depth of the content mapped to the given portion is not beyond the depth threshold.

23. The system of claim 22,
wherein the at least one processor includes a central processing unit (CPU) and a graphics processing unit (GPU),
wherein the CPU is configured to execute the application, and
wherein the GPU is configured to perform the method of rendering graphics.

24. The system of claim 22, further comprising a display device,
wherein the method further comprises presenting the graphics on the display device.

25. The system of claim 22,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion.

26. The system of claim 22,
wherein the sequence of motion includes a plurality of frames,
wherein a) and b) are repeated for each said frame,
wherein the one or more portions is a plurality of portions,
wherein each said portion is a pixel,
wherein, within each said frame, i), ii), and iii) are repeated for each said pixel.

27. The system of claim 22,
wherein the one or more portions collectively define one or more vertical columns of the viewing window.

28. The system of claim 22,
wherein the one or more portions collectively define one or more vertical columns of the viewing window,
wherein each said vertical column is a rectangular bar.

29. The system of claim 22,
wherein the one or more portions collectively define one or more vertical columns of the viewing window,
wherein each said vertical column is a rectangular bar that extends an entire height of the viewing window.

30. The system of claim 22,
wherein the one or more portions collectively define a frame at a periphery of the viewing window.

31. The system of claim 22, further comprising a pixel shader contained in the memory,
wherein the pixel shader performs said rendering the reference image in b).

32. The system of claim 22,
wherein said occluding the content in ii) includes rendering the reference image as partially see-through so that the content occluded by the reference image is partially visible.

33. The system of claim 22,
wherein said occluding the content in ii) includes rendering the reference image as partially see-through so that the content occluded by the reference image is partially visible,
wherein said rendering the reference image as partially see-through includes alpha blending parameter values of the content with parameter values of the reference image.

34. The system of claim 22, further comprising a pixel shader contained in the memory,
wherein the sequence of motion includes a plurality of frames,
wherein a) and b) are repeated for each said frame,
wherein the one or more portions is a plurality of portions,
wherein each said portion is a pixel,
wherein, within each said frame, i), ii), and iii) are repeated for each said pixel by a pixel shader executed by the processor.

35. The system of claim 22, further comprising a pixel shader contained in the memory,
wherein the sequence of motion includes a plurality of frames,
wherein a) and b) are repeated for each said frame,
wherein the one or more portions is a plurality of portions,
wherein each said portion is a pixel,
wherein, within each said frame, i), ii), and iii) are repeated for each said pixel by a pixel shader executed by the processor,
wherein said occluding the content with the reference image in ii) includes rendering an opaque reference image pixel by discarding pixel parameter values of the content and replacing them with reference image pixel parameter values.

36. The system of claim 22, further comprising a pixel shader contained in the memory,
wherein the sequence of motion includes a plurality of frames,
wherein a) and b) are repeated for each said frame by,
wherein the one or more portions is a plurality of portions,
wherein each said portion is a pixel,
wherein, within each said frame, i), ii), and iii) are repeated for each said pixel by a pixel shader executed by the processor,
wherein said occluding the content with the reference image in ii) includes rendering a semi-transparent reference image pixel by alpha blending pixel parameter values of the content with reference image pixel parameter values.

37. The system of claim 22,
wherein said rendering the reference image in b) comprises rendering the reference image in a color that matches a display device casing.

38. The system of claim 22,
wherein the application is an interactive video game,
wherein the three-dimensional content is game play footage of the interactive video game.

39. The system of claim 22,
wherein the application is an interactive video game,
wherein the three-dimensional content is game play footage of the interactive video game,
wherein said rendering the reference image in b) comprises rendering the reference image in real-time during game play.

40. The system of claim 22,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein said rendering the reference image in b) comprises rendering the reference image with one or more different sets of parameters at one or more different respective repetitions of b), such that the parameters of the reference image are dynamic over time across the sequence of motion.

41. The system of claim 22,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein said rendering the reference image in b) comprises rendering the reference image with identical sets of parameters at each different respective repetition of b), such that the parameters of the reference image are static over time across the sequence of motion.

42. The system of claim 22,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein, within each said time increment, said occluding the content with the reference image in ii) comprises rendering the given portion of the reference image with one or more different parameters at one or more different respective repetitions of ii), such that the parameters of the reference image are spatially non-uniform across the viewing window.

43. The system of claim 22,
wherein the sequence of motion includes a plurality of time increments,
wherein a) and b) are repeated for each said time increment,
wherein the one or more portions is a plurality of portions,
wherein, within each said time increment, i), ii), and iii) are repeated for each said portion,
wherein, within each said time increment, said occluding the content with the reference image in ii) comprises rendering the given portion of the reference image with identical parameters each different respective repetition of ii), such that the parameters of the reference image are spatially uniform across the viewing window.

44. The system of claim 22, further comprising a pixel shader contained in the memory,
wherein the at least one processor includes a central processing unit (CPU) and a graphics processing unit (GPU),
wherein the CPU is configured to execute the application,
wherein the GPU is configured to perform the method of rendering graphics,
wherein the application is an interactive video game,
wherein the three-dimensional content is game play footage of the interactive video game,
wherein the sequence of motion includes a plurality of frames,
wherein a) and b) are repeated for each said frame,
wherein the one or more portions is a plurality of pixels that collectively define one or more vertical columns of the viewing window,
wherein, within each said frame, i), ii), and iii) are repeated for each said pixel by the pixel shader executed by the GPU.

45. A non-transitory computer readable medium having processor-executable instructions embodied therein, wherein execution of the instructions by a processor causes the processor to implement a method of rendering graphics, the graphics including three-dimensional content depicting a sequence of motion, the method comprising:
a) rendering the three-dimensional content as mapped to a two-dimensional viewing window; and
b) rendering a reference image onto the viewing window in addition to the three-dimensional content, wherein the reference image is defined at one or more portions of the viewing window, wherein the one or more portions are less than an entirety of the viewing window, and wherein said rendering the reference image in b) comprises, for each given portion of the one or more portions:
i) determining whether a depth of the three-dimensional content mapped to the given portion is beyond a depth threshold by checking a depth value of the content contained in a depth buffer,
ii) occluding the content mapped to the given portion with the reference image when it is determined in i) that the depth of the content mapped to the given portion is beyond the depth threshold, and
iii) occluding the reference image with the content mapped to the given portion when it is determined in i) that the depth of the content mapped to the given portion is not beyond the depth threshold.
